(19) United States
(12) Patent Application Publication
(10) Pub. No.: US 2023/0389616 A1
(43) Pub. Date: Dec. 7, 2023

(54) AEROSOL GENERATING DEVICE AND OPERATION METHOD THEREOF

(71) Applicant: KT&G CORPORATION, Daejeon (KR)

(72) Inventors: Yong Hwan KIM, Gyeonggi-do (KR); Sung Wook YOON, Gyeonggi-do (KR); Seung Won LEE, Gyeonggi-do (KR); Seok Su JANG, Daejeon (KR); Dae Nam HAN, Seoul (KR)

(73) Assignee: KT&G CORPORATION, Daejeon (KR)

(21) Appl. No.: 18/033,687

(22) PCT Filed: Nov. 10, 2021
(86) PCT No.: PCT/KR2021/016354

§ 371 Date: Apr. 25, 2023

(30) Foreign Application Priority Data
Nov. 10, 2020 (KR) 10-2020-0149598

(51) Int. Cl. A24F 40/53; A24F 40/80; G05B 19/406

(52) U.S. Cl. CPC A24F 40/53; A24F 40/80; G05B 19/406

(57) ABSTRACT

A method, performed by an aerosol generating device, of performing a self-diagnosis, includes: when the aerosol generating device does not normally operate by an error, determining whether to activate the self-diagnosis for analyzing the error of the aerosol generating device; when the self-diagnosis is activated, performing a function self-test by checking whether each of functions required for a normal heating operation of the aerosol generating device is operative; determining a faulty component of the aerosol generating device based on a result of the function self-test; determining a faulty function of the faulty component based on an error log recorded in the aerosol generating device; determining a severity of the determined faulty function; and outputting a final diagnosis result with respect to the self-diagnosis based on the faulty component, the faulty function, and the severity.

### TECHNICAL FIELD

One or more embodiments relates to an aerosol generating device and an operation method thereof, and more particularly, to a self-diagnosis function of the aerosol generating device.

### BACKGROUND ART

Recently, demand for alternatives to traditional combustive cigarettes has increased. For example, there is growing demand for an aerosol generating device that generates an aerosol by heating an aerosol generating material contained in an aerosol generating article (i.e., cigarette), without combustion. Accordingly, research on aerosol generating articles and aerosol generating devices has been actively conducted.

### DISCLOSURE

### Technical Problem

Since an aerosol generating device is an electronic device, and errors or breakdowns may occur in hardware modules or software operations in the device. However, it is difficult for a user to accurately identify causes of the errors or the breakdowns and take appropriate measures.

Various embodiments provide an aerosol generating device having a self-diagnosis function and an operation method of the aerosol generating device. The technical problems of the present disclosure are not limited to the above-described description, and other technical problems may be derived from the embodiments to be described hereinafter.

### Technical Solution

According to one or more embodiments, a method of performing a self-diagnosis by an aerosol generating device includes: when the aerosol generating device does not normally operate by an error, determining whether to activate the self-diagnosis for analyzing the error of the aerosol generating device; when the self-diagnosis is activated, performing a function self-test by checking whether each of functions required for a normal heating operation of the aerosol generating device is operative;

determining a faulty component of the aerosol generating device based on a result of the function self-test; determining a faulty function of the faulty component based on an error log recorded in the aerosol generating device; determining a severity of the determined faulty function; and outputting a final diagnosis result with respect to the self-diagnosis based on the faulty component, the faulty function, and the severity.

### Advantageous Effects

According to the description above, when an aerosol generating device does not normally operate because of an error, the aerosol generating device may perform a self-diagnosis and provide a result of the diagnosis about a cause of the error occurrence, and thus a user may be able to easily identify the cause of the error of the aerosol generating device and resolve the error. Also, a service center may utilize the result of the self-diagnosis of the aerosol generating device to accurately identify the cause of the error and repair the aerosol generating device.

### DESCRIPTION OF DRAWINGS

FIG. 1 is a block diagram of hardware components of an aerosol generating device according to an example embodiment.

FIGS. 2A through 2E illustrate various examples of the aerosol generating device of FIG. 1.

FIG. 3 is a view for describing an aerosol generating device performing self-diagnosis, according to an example embodiment.

FIG. 4 is a flowchart for describing a process of activating a self-diagnosis by an aerosol generating device, according to an example embodiment.

FIG. 5 is a flow chart of an entire process of a self-diagnosis performed by an aerosol generating device, according to an example embodiment.

FIG. 6 is a data representing an error log stored in a memory of an aerosol generating device, according to an example embodiment.

FIG. 7 is a flow chart of a primary diagnosis process of a self- diagnosis of an aerosol generating device, according to an example embodiment.

FIG. 8 is a flow chart of a secondary diagnosis process of a self-diagnosis of an aerosol generating device, according to an example embodiment.

FIG. 9 is a flow chart of a tertiary diagnosis process of a self-diagnosis of an aerosol generating device, according to an example embodiment.

FIG. 10 is a view for describing objects to which a final diagnosis result is to be output, according to an example embodiment.

FIG. 11 is a flowchart of a method of performing a self-diagnosis by an aerosol generating device, according to an example embodiment.

### BEST MODE

According to one or more embodiments, a method of performing a self-diagnosis by an aerosol generating device includes: when the aerosol generating device does not normally operate by an error, determining whether to activate the self-diagnosis for analyzing the error of the aerosol generating device; when the self-diagnosis is activated, performing a function self-test by checking whether each of functions required for a normal heating operation of the aerosol generating device is operative; determining a faulty component of the aerosol generating device based on a result of the function self-test; determining a faulty function of the faulty component based on an error log recorded in the aerosol generating device; determining a severity of the determined faulty function; and outputting a final diagnosis result with respect to the self-diagnosis based on the faulty component, the faulty function, and the severity.

The determining whether or not to activate the self-diagnosis may include, if the error recently occurred in the aerosol generating device or occurred more than a predetermined number of times in the aerosol generating device, determining to activate the self-diagnosis.

The function self-test may be performed with respect to an operating function of a hardware component including at least one of a heater, a sensor, a controller, and a battery included in the aerosol generating device and an execution function of software for controlling a heating operation of the aerosol generating device.

The function self-test may be performed by referring to monitoring information about a use history of the aerosol generating device.

The determining of the faulty component may include filtering the faulty component from among a plurality of components of the aerosol generating device based on accumulated appearance frequencies and recent appearance frequencies of the faulty function associated with the components in the error log.

The determining of the faulty function may include: determining that a function identified by the function self-test is the faulty function of the faulty component if the function identified by the function self-test has a predetermined priority among a plurality of functions associated with the faulty component in the error log.

The method may further include analyzing a flooding detection frequency with respect to the aerosol generating device.

The determining of the severity may include, when the flooding detection frequency is equal to or greater than a first threshold value, determining the severity of the faulty function by using a first set of threshold levels, and when the flooding detection frequency is less than the first threshold value, determining the severity of the faulty function by using a second set of threshold levels.

The final diagnosis result may include a diagnosis result based on flooding, when the flooding detection frequency is equal to or greater than the first threshold value.

The final diagnosis result may include guide information indicating whether or not it is required to disassemble the aerosol generating device.

According to one or more embodiments, an aerosol generating device includes: a heater configured to generate an aerosol by heating an aerosol generating material; a battery; a memory storing information about a use history and an error log of the aerosol generating device; and a controller configured to: when the aerosol generating device does not normally operate by an error, determine whether or not to activate the self-diagnosis for analyzing an error of the aerosol generating device; when the self-diagnosis is activated, analyze an error category by performing a function self-test for checking whether each of functions required for a normal heating operation of the aerosol generating device is operative; determine a faulty component of the aerosol generating device based on a result of the function self-test; determine a faulty function of the faulty component based on an error log recorded in the aerosol generating device; determine a severity of the determined faulty function; and output a final diagnosis result with respect to the self-diagnosis based on the faulty component, the faulty function, and the severity.

The controller may further be configured to, if the error recently occurred in the aerosol generating device or occurred more than a predetermined number of times in the aerosol generating device, determine to activate the self-diagnosis.

The controller may further be configured to filter an faulty component from among a plurality of components of the aerosol generating device based on accumulated appearance frequencies and recent appearance frequencies of the faulty function associated with the components in the error log.

The controller may further be configured to determine that a function identified by the function self-test is the faulty function of the faulty component if the function identified by the function self-test has a predetermined priority among a plurality of functions associated with the faulty component in the error log.

The aerosol generating device may further include a flooding detection module configured to detect flooding with respect to the aerosol generating device. The controller may be further configured to: analyze a flooding detection frequency detected by the flooding detection module; when the flooding detection frequency is equal to or greater than a first threshold value, determine the severity of the faulty function by using a first set of threshold levels; and when the flooding detection frequency is less than the first threshold value, determine the severity of the faulty function by using a second set of threshold levels.

According to one or more embodiments, a non-transitory computer-readable recording medium includes a recording medium having recorded thereon one or more programs including instructions for executing the method described above.

### Mode For Invention

With respect to the terms used to describe the various embodiments, general terms which are currently and widely used are selected in consideration of functions of structural elements in the various embodiments. However, meanings of the terms can be changed according to intention, a judicial precedence, the appearance of new technology, and the like. In addition, in certain cases, a term which is not commonly used can be selected. In such a case, the meaning of the term will be described in detail at the corresponding portion in the description of the present disclosure. Therefore, the terms used in the various embodiments should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and/or operation and can be implemented by hardware components or software components and combinations thereof.

Hereinafter, the embodiments will now be described more fully with reference to the accompanying drawings, in which exemplary embodiments are shown such that one of ordinary skill in the art may easily work the embodiments. The embodiments can, however, be embodied in many different forms and should not be construed as being limited to the embodiments set forth herein.

Hereinafter, embodiments will be described in detail with reference to the drawings.

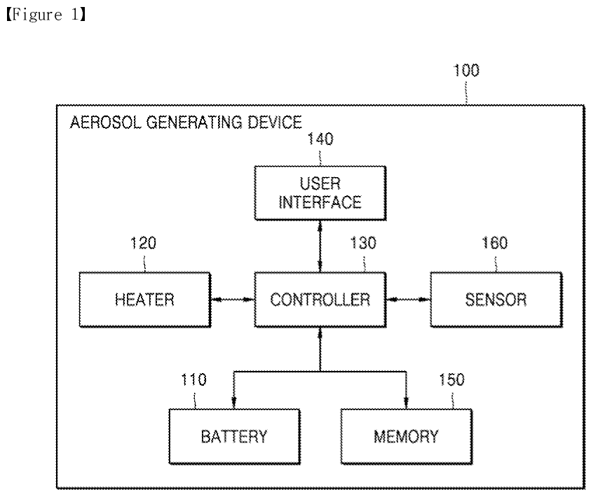

FIG. 1 is a block diagram of hardware components of an aerosol generating device according to an example embodiment.

Referring to FIG. 1, an aerosol generating device 100 may include a battery 110, a heater 120, a controller 130, a user interface 140, a memory 150, and a sensor 160. However, hardware components included in the aerosol generating device 100 are not limited to those illustrated in FIG. 1. It will be understood by one of ordinary skill in the art that according to a design of the aerosol generating device 100, one or more of the hardware components illustrated in FIG. 1 may be omitted, or new components (for example, a flooding detection module, a connecting port, a communication module, etc.) may be further included in the aerosol generating device 100.

Hereinafter, an operation of each component included in the aerosol generating device 100 will be described, without limiting the arrangements of the components.

The battery 110 supplies power used for the aerosol generating device 100 to operate. For example, the battery 110 may supply power to heat the heater 120. In addition, the battery 110 may supply power required for operations of other hardware components included in the aerosol generating device 100, such as the heater 120, the controller 130, the user interface 140, the memory 150, or the sensor 160. The battery 110 may be a rechargeable battery or a disposable battery. For example, the battery 110 may be a lithium polymer (LiPoly) battery or a lithium ion battery, but is not limited thereto.

The heater 120 receives power from the battery 110 according to control by the controller 130. The heater 120 may receive power from the battery 110 to heat a cigarette inserted into the aerosol generating device 100 or heat a cartridge mounted in the aerosol generating device 100. That is, the heater 120 may generate an aerosol by heating an aerosol generating material provided in the cigarette and/or the cartridge.

The heater 120 may be located in a main body of the aerosol generating device 100. Alternatively, when the aerosol generating device 100 includes the main body and the cartridge, the heater 120 may be located in the cartridge. When the heater 120 is located in the cartridge, the heater 120 may receive power from the battery 110 located in at least one of the main body and the cartridge.

The heater 120 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, or nichrome, but is not limited thereto. In addition, the heater 120 may be implemented by a metal wire, a metal plate on which an electrically conductive track is arranged, or a ceramic heating element, but is not limited thereto.

The heater 120 may heat the cigarette inserted into an accommodation space of the aerosol generating device 100. As the cigarette is accommodated in the accommodation space of the aerosol generating device 100, the heater 120 may be located inside and/or outside the cigarette. Accordingly, the heater 120 may heat the aerosol generating material in the cigarette to generate an aerosol.

The heater 120 may be implemented as a component included in the cartridge. The cartridge may include the heater 120, a liquid delivery element, and a liquid storage. An aerosol generating material accommodated in the liquid storage may be moved to the liquid delivery element, and the heater 120 may heat the aerosol generating material absorbed by the liquid delivery element to generate an aerosol. For example, the heater 120 may include a material such as nickel-chromium and may be wound around or arranged adjacent to the liquid delivery element.

The heater 120 may include an induction heater that heats an aerosol generating article (e.g., a cigarette or a cartridge) by an induction heating method. In this case, the heater 120 may include an electrically conductive coil for generating an alternating magnetic field and a susceptor for generating heat in response to the alternating magnetic field.

The controller 130 is a hardware component configured to control general operations of the aerosol generating device 100. The controller 130 may include at least one processor, such as a micro-controller unit (MCU). A processor can be implemented as an array of a plurality of logic gates or can be implemented as a combination of a general-purpose microprocessor and a memory in which a program executable in the microprocessor is stored. It will be understood by one of ordinary skill in the art that the processor can be implemented in other forms of hardware.

The controller 130 analyzes a result of the sensing by at least one sensor 160 and controls processes to be subsequently performed based on the result of the sensing. For example, based on the result of the sensing by the at least one sensor 160, the controller 130 may control power that is to be supplied to the heater 120 such that the operation of the heater 120 is started or terminated. In addition, based on the result of the sensing by the at least one sensor 160, the controller 130 may control the amount of power supplied to the heater 120 and the time in which the power is supplied, so that the heater 120 is heated to or maintained at a predetermined temperature.

The controller 130 may set the heater 120 to a pre-heating mode to start an operation of the heater 120 when the controller 130 receives a user input with respect to the aerosol generating device 100. In addition, the controller 130 may switch the mode of the heater 120 from the pre-heating mode to an operation mode upon sensing a user's puff by using a puff sensor. In addition, the controller 130 may count the number of puffs by using the puff sensor and may stop supplying power to the heater 120 when the number of puffs reaches a preset number.

The controller 130 may control the user interface 140 based on the result of the sensing by the at least one sensor 160. For example, when the number of puffs reaches the preset number after counting the number of puffs by using the puff sensor, the controller 130 may notify the user by using at least one of a lamp, a motor, and a speaker that the aerosol generating device 100 will soon be terminated.

The controller 130 may perform a self-diagnosis with respect to errors or breakdowns occurring in the hardware components of the aerosol generating device 100, such as the battery 110, the heater 120, the user interface 140, the memory 150, and the sensor 160, and control software for controlling these hardware components. The controller 130 may generate an error report about a result of the self-diagnosis. The self-diagnosis performed by the controller 130 will be described in more detail hereinafter by referring to the drawings.

The user interface 140 may provide a user with information about a state of the aerosol generating device 100. The user interface 140 may include various interfacing devices, such as a display or a lamp for outputting visual information, a motor for outputting haptic information, a speaker for outputting sound information, input/output (I/O) interfacing devices (for example, a button or a touch screen) for receiving information input from the user or outputting information to the user, terminals for performing data communication or receiving charging power, and communication interfacing modules for performing wireless communication (for example, Wi-Fi, Wi-Fi direct, Bluetooth, near-field communication (NFC), etc.) with external devices.

The aerosol generating device 100 may be implemented by selecting one or more of the above-described various interfacing devices 140.

The memory 150 may be a hardware component configured to store various pieces of data processed in the aerosol generating device 100, and the memory 150 may store data processed or to be processed by the controller 130. The memory 150 may include various types of memories, such as random access memory, such as dynamic random access memory (DRAM), static random access memory (SRAM), etc., read-only memory (ROM), electrically erasable programmable read-only memory (EEPROM), etc.

The memory 150 may store an operation time of the aerosol generating device 100, the maximum number of puffs, the current number of puffs, at least one temperature profile, data on a user's smoking pattern, water damage information of the aerosol generating device 100, etc. Furthermore, the memory 150 may store use history information of the aerosol generating device 100 or error log information about errors/breakdowns that occurred in the aerosol generating device 100.

Although not illustrated in FIG. 1, an aerosol generating system may be configured by the aerosol generating device 100 and a separate cradle. For example, the cradle may be used to charge the battery 110 of the aerosol generating device 100. The aerosol generating device 100 may be supplied with power from a battery of the cradle to charge the battery 110 of the aerosol generating device 100 while being accommodated in an accommodation space of the cradle.

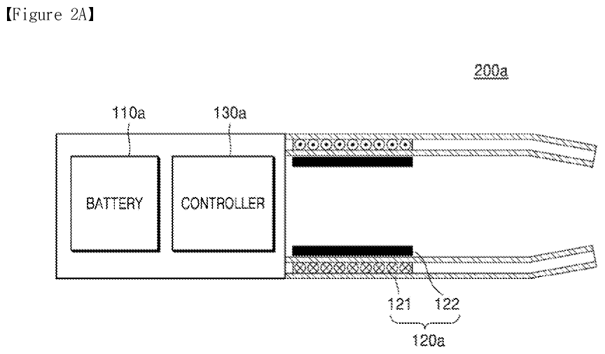

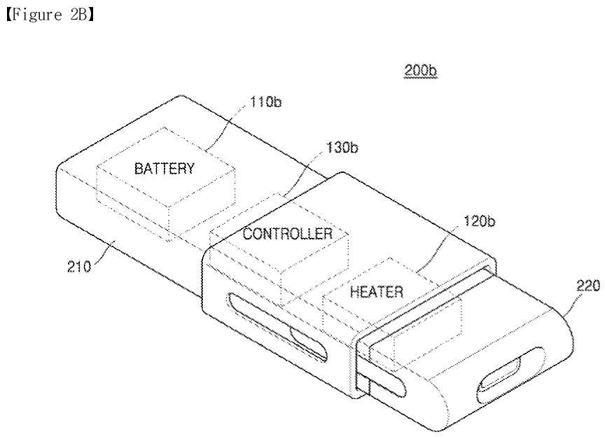

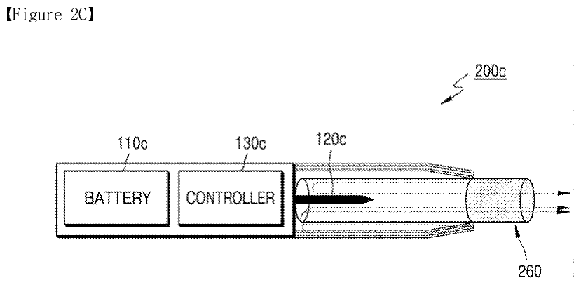

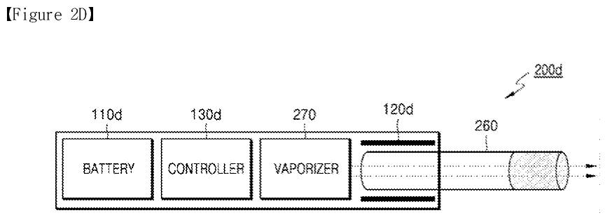

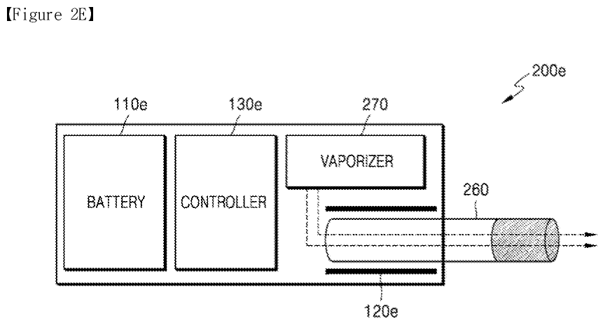

FIGS. 2A through 2E illustrate various examples of the aerosol generating device of FIG. 1. Referring to FIGS. 2A through 2E, the aerosol generating device 100 may be implemented as various types of aerosol generating devices 200a through 200e. In FIGS. 2A through 2E, batteries 110a through 110e, heaters 120a through 120e, and controllers 130a through 130e respectively correspond to the battery 110, the heater 120, and the controller 130 of FIG. 1.

FIG. 2A illustrates an aerosol generating device 200a including a susceptor, according to an example embodiment.

Referring to FIG. 2A, the aerosol generating device 200a may include the heater 120a including a coil 121, a susceptor 122, the battery 110a, and the controller 130a. However, the embodiment is not limited thereto, and the aerosol generating device 200a may further include other general-purpose components in addition to the components illustrated in FIG. 2A.

The aerosol generating device 200a may generate an aerosol by heating a cigarette accommodated in the aerosol generating device 200a by an induction heating method. The induction heating method may refer to a method of heating a magnetic body by applying an alternating magnetic field to a magnetic body such that the magnetic body is heated according to electromagnetic induction. Thus, the aerosol generating device 200a may deliver the heat energy released from the magnetic body to a cigarette to heat the cigarette. Here, the magnetic body heated by the external magnetic field may be the susceptor 122.

The susceptor 122 may be provided in the aerosol generating device 200a or may be included in a cigarette in the shape of a piece, a film, a strip, etc.

The susceptor 122 may be formed as a ferromagnetic body. For example, a material of the susceptor 122 may include metal or carbon. The material of the susceptor 122 may include at least one of a ferrite, a ferromagnetic alloy, stainless steel, and aluminum (Al). Also, the material of the susceptor 122 may include at least one of a ceramic such as graphite or zirconia, a transition metal such as nickel (Ni) or cobalt (Co), and a metalloid such as boron (B) or phosphorous (P).

The aerosol generating device 200a may accommodate a cigarette. The aerosol generating device 200a may include a space for accommodating the cigarette. The susceptor 122 may be arranged around the space for accommodating the cigarette. For example, the susceptor 122 may have a tubular shape and surround the outside of the cigarette. Thus, when the cigarette is accommodated in an accommodation space of the susceptor 122, the susceptor 122 may be arranged to surround at least a portion of an outer circumferential surface of the cigarette. However, the shape of the susceptor 122 is not limited thereto and may vary.

The coil 121 may be arranged to surround an outer surface of the susceptor 122 and may apply an alternating magnetic field to the susceptor 122. When power is supplied to the coil 121 from the aerosol generating device 200a, a magnetic field may be formed in an inner area of the coil 121. When an alternating current is applied to the coil 121, a direction of the magnetic field formed in the coil 121 may be continually changed. When the susceptor 122 is exposed to an alternating magnetic field in the coil 121, the direction of which is periodically changed, the susceptor 122 may be heated, and the cigarette accommodated in the susceptor 122 may be heated.

The battery 110a may supply power to the coil 121 for a heating operation of the aerosol generating device 200a.

The controller 130a may control the heating operation of the heater 120a by controlling the power supplied to the coil 121. For example, the controller 130 may perform a control operation for constantly maintaining a heating temperature of the cigarette.

FIG. 2B is an aerosol generating device including a replaceable cartridge 220 that contains an aerosol generating material, according to an example embodiment.

The aerosol generating device 200b of FIG. 2B includes the cartridge 220 containing the aerosol generating material and a main body 210 supporting the cartridge 220. Here, hardware components of the aerosol generating device 200b may be located in the main body 210 and/or the cartridge 220.

The cartridge 220 containing the aerosol generating material may be coupled to the main body 120. A portion of the cartridge 220 may be inserted into a receptacle of the main body 210, and thus the cartridge 220 may be mounted on the main body 210.

The cartridge 220 may contain an aerosol generating material of a liquid composition. However, the cartridge 220 is not limited thereto and may contain an aerosol generating material in any one of, for example, a solid state, a gaseous state, and a gel state. For example, the liquid composition may be a liquid including a tobacco-containing material having a volatile tobacco flavor component, or a liquid including a non-tobacco material.

The heater 120b provided in the cartridge 220 may perform the heating operation according to an electrical signal or a wireless signal transmitted from the main body 210. Accordingly, the aerosol generating material in the cartridge 220 may be vaporized by the heating operation of the heater 120b, and thus an aerosol may be generated.

The heater 120b may heat the aerosol generating material delivered by a liquid delivery element by generating heat using electrical resistance. To this end, the heater 120b may be implemented by a conductive filament including a metal material, such as copper (Cu), nickel (Ni), or tungsten (W), or a ceramic heating element, and may be wound around the liquid delivery element or arranged adjacent to the liquid delivery element.

FIGS. 2C through 2E are views of the aerosol generating devices 200c through 200e into which a cigarette 260 is inserted, according to example embodiments.

Referring to FIG. 2C, the aerosol generating device 200c may include the battery 100c, the controller 130c, and the heater 120c. Referring to FIGS. 2D and 2E, the aerosol generating devices 200d and 200e may further include the vaporizer 270. The vaporizer 270 may contain an aerosol generating material and may include a separate heater for heating the aerosol generating material. The cigarette 260 may be inserted into the aerosol generating devices 200c through 200e.

FIG. 2C illustrates that the battery 110c, the controller 130c, and the heater 120c are serially arranged in the aerosol generating device 200c. Also, FIG. 2D also illustrates that the battery 110d, the controller 130d, the vaporizer 270, and the heater 120d are serially arranged in the aerosol generating device 200d. On the other hand, FIG. 2E illustrates that the vaporizer 270 and the heater 120e are arranged in parallel with each other in the aerosol generating device 200e. However, internal structures of the aerosol generating devices 200c through 200e are not limited to the illustrations of FIGS. 2C through 2E.

When the cigarette 260 is inserted into the aerosol generating devices 200c through 200e, the aerosol generating devices 200c through 200e may operate the heaters 120c through 120e and/or the vaporizer 270 to generate an aerosol from the cigarette 260 and/or the vaporizer 270. The aerosol generated by the heaters 120c through 120e and/or the vaporizer 270 is delivered to a user by passing through the cigarette 260.

The batteries 110c through 110e supply power used by the aerosol generating devices 200c through 200e to operate.

The vaporizer 270 may generate an aerosol by heating a liquid composition, and the generated aerosol may be delivered to the user by passing through the cigarette 260. In other words, the aerosol generated by the vaporizer 270 may move along an air flow passage of the aerosol generating devices 200d and 200e, and the air flow passage may be configured such that the aerosol generated by the vaporizer 270 is delivered to the user by passing through the cigarette. For example, the vaporizer 270 may include a liquid storage storing the liquid composition, a liquid delivery element (for example, a wick, etc.) delivering a liquid to a heating element, and the heating element (for example, a metal wire, etc.), but is not limited thereto. The vaporizer 270 may be referred to as a cartomizer or an atomizer.

Although not illustrated in FIGS. 2A through 2E, the aerosol generating devices 200a through 200e may form a system together with an additional cradle. For example, the cradle may be used to charge the batteries 110a through 110e of the aerosol generating devices 200a through 200e. Also, while the cradle and the aerosol generating devices 200a through 200e are coupled to each other, the heaters 120a through 120e may perform a heating operation by using power supplied from the cradle.

According to various embodiments, the aerosol generating device 100 of FIG. 1 may be implemented as at least one of various types of aerosol generating devices 200a through 200e of FIGS. 2A through 2E, but is not necessarily limited thereto.

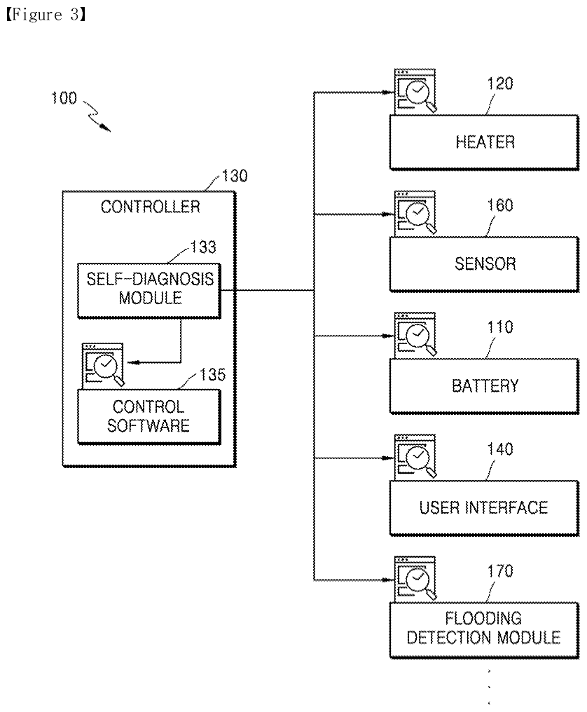

FIG. 3 is a view for describing a self-diagnosis performed by an aerosol generating device, according to an example embodiment.

As described above, the aerosol generating device 100 operates at a relatively high temperature due to the heating operation of the heater 120, unlike other electronic devices. Also, a liquid aerosol generating material contained in the aerosol generating device 100 may be leaked, or the generated aerosol may gradually penetrate into other hardware component through a minute gap in a housing. In this case, errors or breakdowns may occur in the aerosol generating device 100. Thus, for a steady and stable use of the aerosol generating device 100, a fundamental cause of errors or breakdowns occurring in the aerosol generating device 100 need to be identified accurately.

Referring to FIG. 3, the controller 130 of the aerosol generating device 100 may diagnose various types of errors or breakdowns occurring in the aerosol generating device 100 by executing a self-diagnosis module 133. Here, the self-diagnosis module 133 is a software module driven by the controller 130 and corresponds to a diagnosis solution (or a diagnosis program) performing a diagnosis process with respect to various hardware components in the aerosol generating device 100, such as the heater 120, the sensor 160, the battery 110, etc.

The self-diagnosis module 133 may perform a self-diagnosis with respect to the heater 120. For example, when the heater 120 is not heated to a target temperature even though predetermined power is supplied to the heater 120, the self-diagnosis module 133 may make a diagnosis that there is an error in a heating function of the heater 120. Also, when a temperature change is too drastic or the heater 120 is over-heated even though a power supply to the heater 120 is constant, the self-diagnosis module 133 may make a diagnosis that there is an error in the heating function of the heater 120. That is, when the heating of the heater 120 is not normally controlled, the self-diagnosis module 133 may make a diagnosis that an error or a breakdown has occurred in the heater 120.

The self-diagnosis module 133 may perform a self-diagnosis with respect to the sensor 160 included in the aerosol generating device 100, such as a puff sensor, a heater temperature sensor, a battery temperature sensor, etc. When the number of puffs is not counted even though a user puffs on the aerosol generating device 100, the self-diagnosis module 133 may detect that there is an error in the puff sensor. Also, when the temperature sensor senses a temperature incorrectly or a temperature sensing function is stopped, the self-diagnosis module 133 may make a diagnosis that there is a need to replace the temperature sensor. That is, the self-diagnosis module 133 may determine that there is an error or a breakdown in the sensor 160 when a sensing result deviates from an expected range of the sensing result.

The battery 110 supplies power for operations of various hardware components of the aerosol generating device 100. The self-diagnosis module 133 may perform an examination about whether power (e.g., a voltage) provided from the battery 110 is normal, whether a temperature of the battery 110 is normal, etc. When the power is not normally supplied or the temperature of the battery 110 deviates from a normal range, the self-diagnosis module 133 may make a diagnosis that there is an error or a breakdown in the battery 110. Further, the self-diagnosis module 133 may also determine whether or not the battery is capable of performing a normal operation based on a degree of degradation of the battery 110.

The aerosol generating device 100 may additionally include a flooding detection module 170. The self-diagnosis module 133 may monitor the number of times the aerosol generating device 100 gets wet based on a flooding signal generated by the flooding detection module 170 or may make a diagnosis that the aerosol generating device 100 is incapable of performing a normal operation due to severe water damage to the aerosol generating device 100.

The self-diagnosis module 133 may perform a diagnosis with respect to control software 135 controlling an operation of the aerosol generating device 100, as well as the hardware components of the aerosol generating device 100. For example, the self-diagnosis module 133 may diagnose errors of the control software 135 by identifying various software execution errors, such as a collision, a suspension, an update failure, etc. of the control software 135.

After the self-diagnosis module 133 performs the self-diagnosis with respect to the aerosol generating device 100, the self-diagnosis module 133 outputs a self-diagnosis result. The self-diagnosis result may include various error information, such as a location in which an error occurs, an error type, the severity of an error, a solution to an error, etc. A user may instantly take measures against the error of the aerosol generating device 100 based on the self-diagnosis result provided by the self-diagnosis module 133. Hereinafter, processes in which the aerosol generating device 100 performs the self-diagnosis are described in more detail.

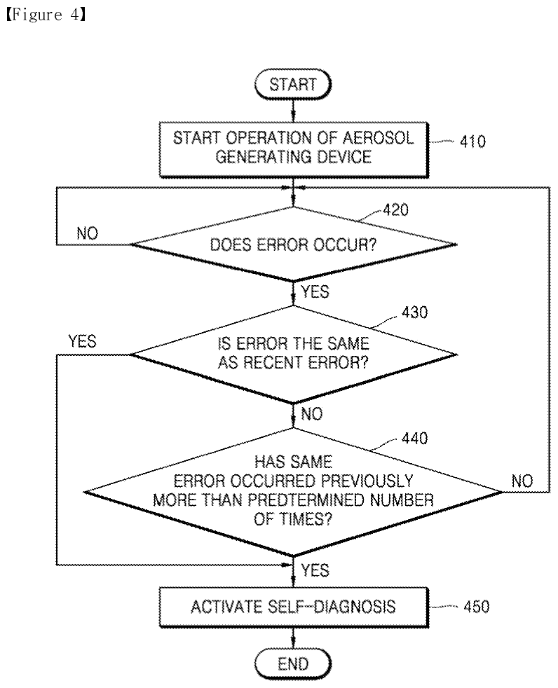

FIG. 4 is a flowchart for describing a process in which an aerosol generating device activates a self-diagnosis, according to an example embodiment.

Referring to FIG. 4, in operation 410, the aerosol generating device (100 of FIG. 1) may start an operation of the aerosol generating device 100 in response to a request of a user. The aerosol generating device 100 may start the operation by receiving a smoking request of the user through an input interface, such as a physical button, a touch screen, etc., or may start the operation when the user inserts a cigarette into the aerosol

In operation 420, the self-diagnosis module 133 of the controller 130 determines whether an error has occurred in the aerosol generating device 100 after the operation of the aerosol generating device 100 was started. That is, the self-diagnosis module 133 determines whether the aerosol generating device 100 does not normally operate. When it is determined that an error has occurred, the self-diagnosis module 133 performs operation 430. However, when it is determined that an error has not occurred, the self-diagnosis module 133 may keep monitoring whether or not an error occurs.

In operation 430, the self-diagnosis module 133 determines whether the current error is the same as an error that recently occurred in the aerosol generating device 100. Here, the recently occurred error may refer to an error that has occurred after a predetermined reference point in time in the past. The predetermined reference point may be variously adjusted.

When it is determined that the error currently occurring is the same as the error that recently occurred, the self-diagnosis module 133 determines that the aerosol generating device is not normally operating and performs operation 450 and activates a self-diagnosis in operation 450. However, when it is determined that the error currently occurring is not the same as the error that recently occurred, the self-diagnosis module 133 performs operation 440.

In operation 440, the self-diagnosis module 133 determines whether the current error is the same as an error that has continually occurred in the past in the aerosol generating device 100. Here, the error that has continually occurred in the past may refer to a type of error that has repeatedly occurred more than a predetermined number of times in the past. The predetermined number of times may be variously adjusted.

When it is determined that the current error is the same as the error that has continually occurred in the past, the self-diagnosis module 133 determines that the aerosol generating device is not normally operating and performs operation 450 to activate a self-diagnosis. However, when it is determined that the current error has not continually occurred in the past, the self-diagnosis module 133 may not activate the self-diagnosis and may keep monitoring whether or not an error occurs.

In operation 450, the self-diagnosis module 133 activates the self-diagnosis for analyzing an error of the aerosol generating device 100 in more detail.

*98The process for activating the self-diagnosis described with reference to FIG. 4 is a process for determining whether or not to start analyzing the error occurring in the aerosol generating device 100. The self-diagnosis module 133 of the aerosol generating device 100 may perform the self-diagnosis for analyzing the error through the processes to be described with reference to the drawings below.

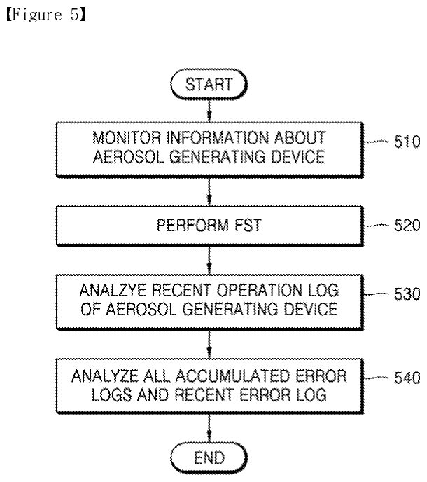

FIG. 5 is a flow chart of a process of a self-diagnosis performed by an aerosol generating device, according to an example embodiment.

Referring to FIG. 5, in operation 510, when the self-diagnosis is activated, the self-diagnosis module 133 monitors information about the aerosol generating device 100. In detail, the self-diagnosis module 133 may refer to monitoring information about a use history of the aerosol generating device 100. For example, the use history of the aerosol generating device 100 indicates history information regarding manipulation or use of the aerosol generating device 100 by a user, such as the number of heating operations performed by the aerosol generating device 100, the number of charging/discharging operations, operation time, the number of times the aerosol generating device 100 is fully discharged, repair histories, etc. Through the monitoring of the use history described above, the self-diagnosis module 133 may pre-identify which functions are mainly used, which functions are wrongly used, etc. in the aerosol generating device 100 and may refer to the pre-identified information to accurately perform a diagnosis in subsequent diagnosis processes.

In operation 520, the self-diagnosis module 133 performs a function self-test (FST) for checking whether each of functions required for a normal heating operation of the aerosol generating device 100 is normally operating. The self-diagnosis module 133 may determine an error category based on a result of the FST.

As described with reference to FIG. 3, the FST may be performed by the self-diagnosis module 133 with respect to the hardware components included in the aerosol generating device 100, such as the heater 120, the sensor 160, the controller 130, and the battery 110, and with respect to the control software for controlling the heating operation of the aerosol generating device 100. That is, the self-diagnosis module 133 checks whether each hardware component and the software is normally operating through the FST.

In operation 530, the self-diagnosis module 133 analyzes a recent operation log of the aerosol generating device 100. The recent operation log specifies the operative state of the aerosol generating device 100 has with respect to an error occurrence, such as the most recent operative state of the heater, a battery voltage, a heater temperature, etc.

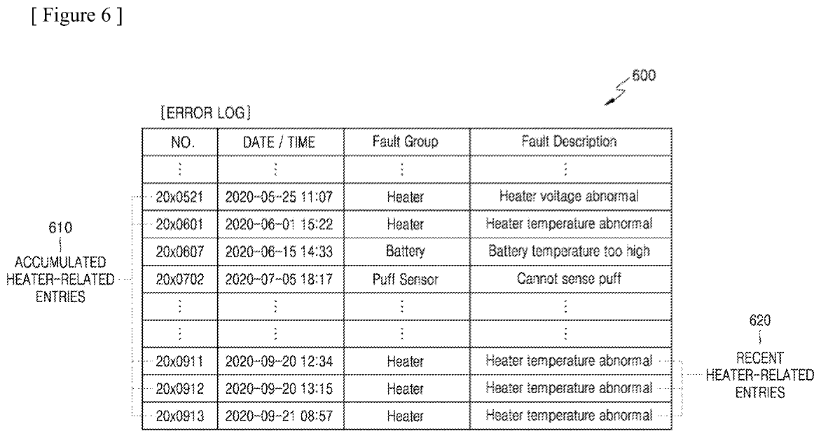

In operation 540, the self-diagnosis module 133 analyzes an error log (see FIG. 6) of the aerosol generating device 100 to determine an error category (e.g., malfunctioning component) and a specific error item (e.g., description of malfunction). For example, the self-diagnosis module 133 may determine the error category and the error item based on the appearance frequencies of error categories and error items in the error log of the aerosol generating device 100.

FIG. 6 is a data table representing an error log stored in a memory of an aerosol generating device, according to an example embodiment.

Referring to FIG. 6, the error log entries are chronologically arranged in the data table 600. Each error log entry includes information about an error category (e.g., faulty component) in the “fault group” column and information about a specific error item (e.g., faulty function of the faulty component) in the “fault description” column.

For example, when it is estimated that there is a problem in the heater function as a result of the FST with respect to the aerosol generating device 100, the self-diagnosis module 133 obtains the entire heater-related error log entries 610 and recent heater-related error log entries 620 from the error log. Then, the self-diagnosis module 133 compares the heater-related error log entries 610 and 620 with the result of the FST and an operation log of the aerosol generating device. Based on the comparison, the self-diagnosis module 133 may determine that the error category is related to the heater. For example, the self-diagnosis module 133 may determine that the error is related to the heater if the number of the entire heater-related log entries 610 exceeds a certain threshold. Also, the self-diagnosis module 133 may also determine that the error category is related to the heater if the number of the recent heater-related log entries 620 exceeds a certain threshold. The reference time for determining whether an error log entry is recent or not may vary according to embodiments.

The data table 600 representing the error log illustrated in FIG. 6 is only an example. In other words, the error log managed by the aerosol generating device 100 may be different from the data table 600 of FIG. 6.

Hereinafter, the entire process of the self-diagnosis described above with reference to FIG. 5 is to be described by dividing the entire process into a primary diagnosis process, a secondary diagnosis process, and a tertiary diagnosis process.

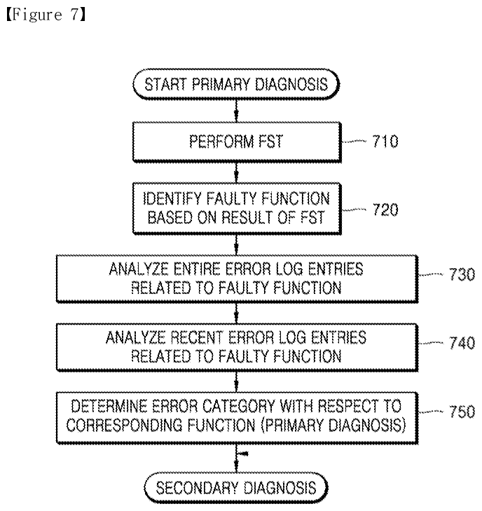

FIG. 7 is a flow chart of the primary diagnosis process of the self-diagnosis of the aerosol generating device, according to an example embodiment. Referring to FIG. 7, in the primary diagnosis process, the self-diagnosis module 133 determines an error category by performing an FST for checking whether each of functions required for a normal heating operation of the aerosol generating device 100 is normally operating or not.

In detail, in operation 710, the self-diagnosis module 133 performs the FST for checking whether all of the functions of the aerosol generating device 100 (for example, the operating function of the hardware components and the executing function of the software) are normally operating or not.

In operation 720, the self-diagnosis module 133 identifies a faulty function (i.e., a function in which an error has occurred), based on a result of the FST.

In operation 730, the self-diagnosis module 133 analyzes the entire error log entries related to the identified faulty function. For example, if the faulty function is related to a heater, the self-diagnosis module 133 may analyze the error log entries 610 included in the data table 600 of FIG. 6.

In operation 740, the self-diagnosis module 133 analyzes recent error log entries related to the identified faulty function. For example, if the faulty function is related to a heater, the self-diagnosis module 133 may analyze the error log entries 620 included in the data table 600 of FIG. 6. As described above, a reference time for determining whether an error log entry is recent or not may vary according to embodiments.

In operation 750, the self-diagnosis module 133 determines the error category with respect to the faulty function, based on the appearance frequency of the faulty function analyzed in operation 730 and 740. For example, when the result of the FST indicates that a heater temperature is not precisely controlled, such faulty function may be due to a malfunctioning voltage (e.g., unstable battery voltage) or a malfunctioning heater. In this regard, the self-diagnosis module 133 may determine whether the error category is related to the heater or the battery. For example, the self-diagnosis module 133 may determine that the error category is related to the heater when an appearance frequency of an error related to the heater (e.g., “abnormal heater temperature”) in the error log is high. On the other hand, the self-diagnosis module 133 may determine that the error category is related to the battery when an appearance frequency of an error related to the battery (e.g., “unstable battery voltage”) in the error log is high.

The error category determined in operation 750 is a result of the primary diagnosis of the self-diagnosis, and the self-diagnosis module 133 may perform the secondary diagnosis process for a more detailed diagnosis.

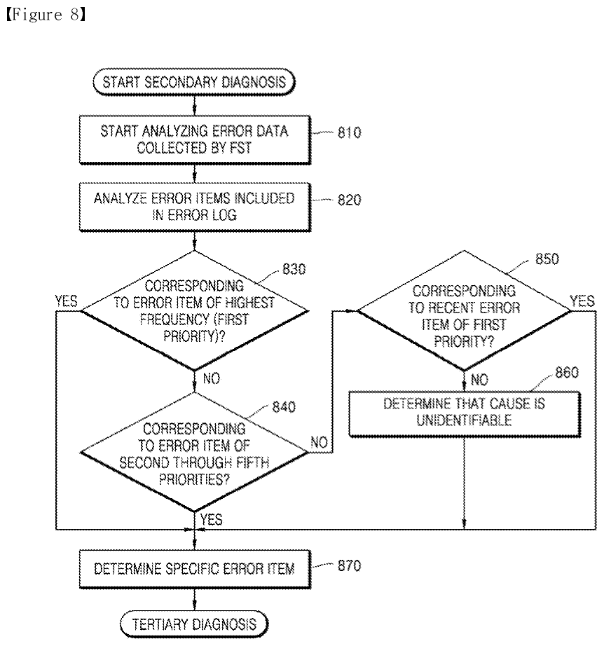

FIG. 8 is a flow chart of the secondary diagnosis process of the self-diagnosis of the aerosol generating device, according to an example embodiment. Referring to FIG. 8, in the secondary diagnosis process, the self-diagnosis module 133 determines specific error items in the error category determined in the primary diagnosis by analyzing error data collected by the FST based on the error log recorded in the aerosol

In detail, in operation 810, the self-diagnosis module 133 obtains the error data collected by the FST and starts analyzing the obtained error data.

In operation 820, the self-diagnosis module 133 analyzes the error data collected by the FST, based on the error log.

In operation 830, the self-diagnosis module 133 determines whether or not the faulty function identified in the error data corresponds to an error item (i.e., faulty function) having a first priority among the entire error items of the error category determined in the primary diagnosis in the error log. The error item having the first priority may be an error item having a fatal effect on a function of the aerosol generating device 100. For example, priorities of the error items may be determined based on the appearance frequencies of the error items associated with the error category in the error log. In this case, the error item having the highest appearance frequency may have the first priority. However, it is not limited thereto, and priorities of error items may be variously adjusted according to embodiments. When it is determined that the faulty function identified by the FST corresponds to the error item having the first priority in the error log, the self-diagnosis module 133 performs operation 870. However, when it is determined that the faulty function identified by the FST does not correspond to the error item having the first priority in the error log, the self-diagnosis module performs operation 840.

In operation 840, the self-diagnosis module 133 determines whether or not the faulty function identified in the error data corresponds to error items having next priorities (for example, second through fifth priorities) among the entire error items of the error category determined in the primary diagnosis in the error log. As described above, the priority order of the error items may be variously adjusted according to embodiments. When it is determined that the faulty function identified by the FST corresponds to one of the error items having the next priority orders, the self-diagnosis module 133 performs operation 870. Otherwise, the self-diagnosis module 133 performs operation 850.

In operation 850, the self-diagnosis module 133 determines whether or not the faulty function identified by the FST corresponds to an error item having a first priority among recent error items of the error category determined in the primary diagnosis in the error log. When it is determined that the faulty function identified by the FST corresponds to the recent error item having the first priority, the self-diagnosis module 133 performs operation 870. Otherwise, the self-diagnosis module 133 performs operation 860.

In operation 860, the self-diagnosis module 133 determines that a cause of to the error cannot be identified based on the error log.

In operation 870, the self-diagnosis module 133 determines that an error item having one of the first to fifth priorities among the entire error items of the error category determined in the primary diagnosis or an error item having the first priority among the recent error items of the error category determined in the primary diagnosis is the specific error item corresponding to the faulty function identified by the FST. However, when it is determined that the specific error item is unidentifiable in operation S860, the self-diagnosis module 133 determines that an error having the unidentifiable cause is the specific error item.

According to the secondary diagnosis process described with reference to FIG. 8, the self-diagnosis module 133 determines that an error item having a predetermined priority among error items of the determined error category in the error log is the specific error item corresponding to the faulty function identified by the FST. However, when such error item is not found in the error log, the specific error item may be determined to be an error item having an unidentifiable cause.

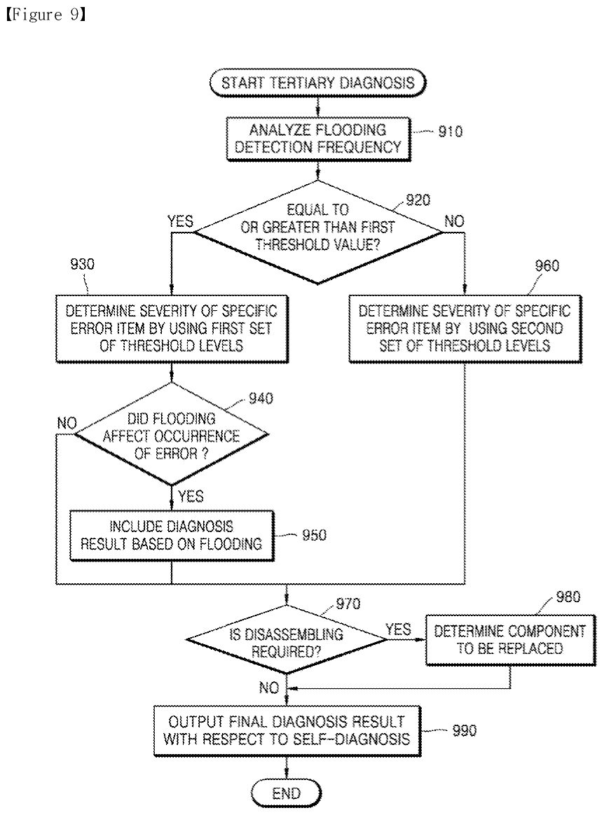

FIG. 9 is a flow chart of the tertiary diagnosis process of the self-diagnosis of the aerosol generating device, according to an example embodiment. Referring to FIG. 9, in the tertiary diagnosis process, the self-diagnosis module 133 determines the severity of the determined specific error item and outputs a final diagnosis result with respect to the self-diagnosis based on the error category, the specific error item, and the severity.

In detail, in operation 910, the self-diagnosis module 133 analyzes a number of times the flooding detection module (170 of FIG. 3) detected flooding in the past.

In operation 920, the self-diagnosis module 133 determines whether the flooding detection frequency is equal to or greater than a first threshold value. Here, the first threshold value is a pre-set value according to a use environment of the aerosol generating device 100 and may be adjusted. For example, when the aerosol generating device 100 includes a liquid aerosol generating material, the first threshold value may be set to be relatively low, and when the aerosol generating device 100 does not include the liquid aerosol generating material and uses only a solid aerosol generating material, the first threshold value may be set to be relatively high. However, the described manner of setting the first threshold value is only an example, and the first threshold value may be pre-set to various values that are appropriate according to the use environment, as described above.

In operation 930, when the flooding detection frequency is equal to or greater than the first threshold value, the self-diagnosis module 133 determines the severity of the specific error item by using a first set of threshold levels.

In operation 940, the self-diagnosis module 133 determines whether or not flooding is the cause of an error, based on the flooding detection frequency.

In operation 950, when it is determined that flooding affected the occurrence of the error, the self-diagnosis module 133 includes the diagnosis result based on the flooding in a final diagnosis result. That is, the self-diagnosis module 133 may include the diagnosis result based on the flooding in the final diagnosis result, when the flooding detection frequency is equal to or greater than the first threshold value.

In operation 960, when the flooding detection frequency is less than the first threshold value, the self-diagnosis module 133 determines the severity of the specific error item by using a second set of threshold levels.

The first set of threshold levels and the second set of threshold levels for determining the severity are different from each other. For example, when a user neatly uses the aerosol generating device 100, the flooding detection frequency may be relatively low. In contrast, when the user uses the aerosol generating device 100 in a relatively relentless manner, the flooding detection frequency may be relatively high. In this respect, the error severity of the aerosol generating device 100 neatly used may be lower than the error severity of the aerosol generating device 100 relentlessly used. Thus, the self-diagnosis module 133 may determine the error severity by using different sets of threshold levels by taking into account the flooding detection frequency from which a maintenance state of the aerosol generating device 100 of the user may be inferred.

The threshold levels are configured to identify the severity in a stepwise manner based on the frequency of the occurrence of an error item. The threshold levels may be pre-set according to a type of an error item, a use environment of the aerosol generating device 100, etc.

In operation 970, the self-diagnosis module 133 determines whether or not it is needed to disassemble the aerosol generating device 100 by taking into account a type of a specific error item, the severity of the specific error item, etc.

When it is determined that the disassembling is required, the self-diagnosis module 133 determines a component the aerosol generating device 100 which needs to be replaced, in operation 980.

In operation 990, the self-diagnosis module 133 outputs the final diagnosis result with respect to the self-diagnosis based on the error category, the specific error item, and the severity. Here, the final diagnosis result may include guide information about the component to be replaced, which is determined in operation 980.

As described with reference to FIGS. 3 through 9, through the self-diagnosis process (that is, the primary through tertiary diagnosis processes) performed by the controller 130, the aerosol generating device 100 may provide a diagnosis result by directly entering into a self-diagnosis mode when an error occurs.

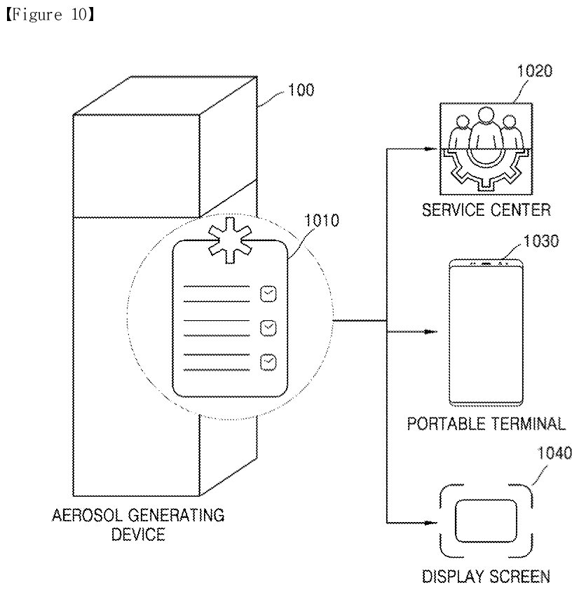

FIG. 10 is a view for describing objects to which a final diagnosis result is to be output, according to an example embodiment. Referring to FIG. an error report 1010 corresponding to the final diagnosis result generated by the self-diagnosis performed by the aerosol generating device 100 may be output to various destinations.

For example, when a user brings the aerosol generating device 100 to a service center 1020, the service center 1020 may connect the aerosol generating device 100 to a diagnosis device and access/download the error report 1010 from the aerosol generating device 100. Based on this operation, the service center 1020 may identify an error of the aerosol generating device 100 and repair or replace a component having the error/breakdown, and thus, the error of the aerosol generating device 100 may be resolved.

Alternatively, the aerosol generating device 100 may transmit the error report 1010 to a portable terminal 1030, such as a smart phone, a tablet, etc., through wired or wireless communication. The user may identify the error report 1010 on the portable terminal 1030 and then bring the aerosol generating device 100 to the service center 1020 or directly repair the aerosol generating device 100.

Furthermore, the aerosol generating device 100 may display the error report 1010 through a display screen 1040 of the user interface 140.

The error report 1010, which is the final diagnosis result generated as a result of the self-diagnosis, may be output/provided via various other methods so that the user may easily identify the cause of the error.

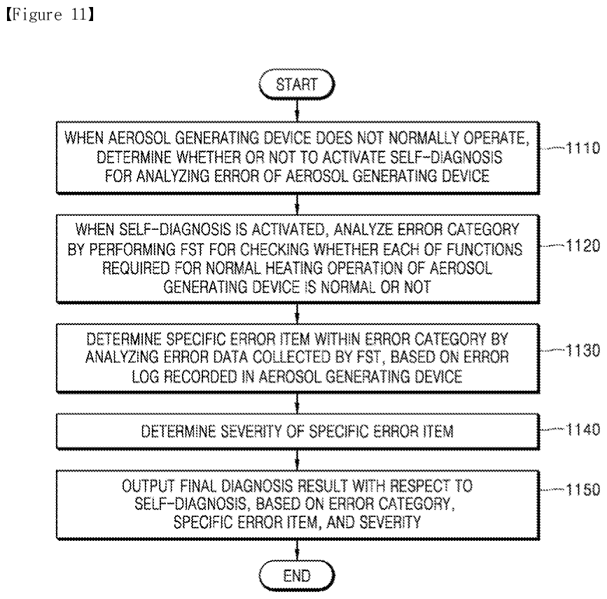

FIG. 11 is a flowchart of a method of performing a self-diagnosis by an aerosol generating device, according to an example embodiment. Referring to FIG. 11, the self-diagnosis method of the aerosol generating device 100 includes the operations sequentially performed by the aerosol generating device 100 described above with reference to the drawings. Thus, although omitted below, the aspects described with respect to the aerosol generating device 100 with reference to the above drawings may be applied to the method of FIG. 11.

In operation 1110, the controller 130 (that is, the self-diagnosis module 133) determines whether or not to activate a self-diagnosis for analyzing an error of the aerosol generating device 100, when the aerosol generating device 100 does not normally operate.

In operation 1120, when the self-diagnosis is activated, the controller 130 analyzes an error category by performing an FST for checking whether each of functions required for a normal heating operation of the aerosol generating device 100 is normally performed or not.

In operation 1130, the controller 130 determines a specific error item within the error category by analyzing error data collected by the FST based on an error log.

In operation 1140, the controller 130 determines the severity of the determined specific error item.

In operation 1150, the controller 130 outputs a final diagnosis result with respect to the self-diagnosis based on the error category, the specific error item, and the severity.

The method described above may be composed as a program that is executable by a computer and may be implemented by a general-purpose digital computer for operating the program by using a non-transitory computer-readable recording medium. Also, a data structure used in the method described above may be recorded on the computer-readable recording medium by using various elements. The computer-readable recording medium includes a storage medium, such as a magnetic storage medium (for example, ROM, RAM, USB, a floppy disk, a hard disk, etc.) and an optical reading medium (for example, a CD-ROM, a DVD, etc.)

One of ordinary skill in the art pertaining to the present embodiments can understand that various changes in form and details can be made therein without departing from the scope of the characteristics described above. The disclosed methods should be considered in a descriptive sense only and not for purposes of limitation. The scope of the present embodiments is not reflected in the descriptions above and is reflected in the claims, and all differences within the equivalent scope shall be interpreted to be included in the present embodiments.

1. A method of performing a self-diagnosis by an aerosol generating device, the method comprising:
when the aerosol generating device does not normally operate by an error, determining whether to activate the self-diagnosis for analyzing the error of the aerosol generating device;
when the self-diagnosis is activated, performing a function self-test by checking whether each of functions required for a normal heating operation of the aerosol generating device is operative;
determining a faulty component of the aerosol generating device based on a result of the function self-test;
determining a faulty function of the faulty component based on an error log recorded in the aerosol generating device;
determining a severity of the determined faulty function; and
outputting a final diagnosis result with respect to the self-diagnosis based on the faulty component, the faulty function, and the severity.

2. The method of claim 1, wherein the determining whether to activate the self-diagnosis comprises, if the error recently occurred in the aerosol generating device or occurred more than a predetermined number of times in the aerosol generating device, determining to activate the self-diagnosis.

3. The method of claim 1, wherein the function self-test is performed with respect to an operating function of a hardware component including at least one of a heater, a sensor, a controller, and a battery included in the aerosol generating device, and an execution function of software for controlling a heating operation of the aerosol generating device.

4. The method of claim 1, wherein the function self-test is performed by referring to monitoring information about a use history of the aerosol generating device.

5. The method of claim 1, wherein the determining of the faulty component comprises filtering the faulty component from among a plurality of components of the aerosol generating device based on accumulated appearance frequencies and recent appearance frequencies of the faulty function associated with the components in the error log.

6. The method of claim 1, wherein the determining of the faulty function comprises:
determining that a function identified by the function self-test is the faulty function of the faulty component, if the function identified by the function self-test has a predetermined priority among a plurality of functions associated with the faulty component in the error log.

7. The method of claim 1, further comprising analyzing a flooding detection frequency with respect to the aerosol generating device, wherein
the determining of the severity comprises, when the flooding detection frequency is equal to or greater than a predetermined threshold value, determining the severity of the faulty function by using a first set of threshold levels, and when the flooding detection frequency is less than the first threshold value, determining the severity of the faulty function by using a second set of threshold levels.

8. The method of claim 7, wherein the final diagnosis result comprises a diagnosis result based on flooding, when the flooding detection frequency is equal to or greater than the predetermined threshold value.

9. The method of claim 1, wherein the final diagnosis result comprises guide information indicating whether it is required to disassemble the aerosol generating device.

10. An aerosol generating device comprising:
a heater configured to generate an aerosol by heating an aerosol generating material;
a battery;
a memory storing information about a use history and an error log of the aerosol generating device; and
a controller configured to:
when the aerosol generating device does not normally operate by an error, determine whether to activate a self-diagnosis for analyzing the error of the aerosol generating device;
when the self-diagnosis is activated, perform a function self-test for checking whether each of functions required for a normal heating operation of the aerosol generating device is operative;
determine a faulty component of the aerosol generating device based on a result of the function self-test;
determine a faulty function of the faulty component based on an error log recorded in the aerosol generating device;
determine a severity of the determined faulty function; and
output a final diagnosis result with respect to the self-diagnosis based on the faulty component, the faulty function, and the severity.

11. The aerosol generating device of claim 10, wherein the controller is further configured to, if the error recently occurred in the aerosol generating device or occurred more than a predetermined number of times in the aerosol generating device, determine to activate the self-diagnosis.

12. The aerosol generating device of claim 10, wherein the controller is further configured to filter an faulty component from among a plurality of components of the aerosol generating device based on accumulated appearance frequencies and recent appearance frequencies of the faulty function associated with the components in the error log.

13. The aerosol generating device of claim 10, wherein the controller is further configured to determine that a function identified by the function self-test is the faulty function of the faulty component if the function identified by the function self-test has a predetermined priority among a plurality of functions associated with the faulty component in the error log.

14. The aerosol generating device of 10, further comprising a flooding detection module configured to detect flooding with respect to the aerosol generating device, wherein
the controller is further configured to:
analyze a flooding detection frequency detected by the flooding detection module;
when the flooding detection frequency is equal to or greater than a predetermined threshold value, determine the severity of the faulty function by using a first set of threshold levels; and
when the flooding detection frequency is less than the predetermined threshold value, determine the severity of the faulty function by using a second set of threshold levels.

15. A non-transitory computer-readable recording medium having recorded thereon a program for executing the method of claim 1 on a computer.
